(19) United States
(12) Patent Application Publication
(10) Pub. No.: US 2010/0316821 A1
(43) Pub. Date: Dec. 16, 2010

(54) MULTI-LAYER FILMS, SHEETS, AND HOLLOW ARTICLES WITH THERMAL MANAGEMENT FUNCTION FOR USES AS CASINGS OF SECONDARY BATTERIES AND SUPERCAPACITORS, AND SLEEVES OF SECONDARY BATTERY AND SUPERCAPACITOR PACKS

(75) Inventors: CHIEN-LUNG CHANG, Taipei County (TW); CHIEN-LUNG WEI, Keelung City (TW)

Correspondence Address: WPAT, PC;INTELLECTUAL PROPERTY ATTORNEYS, 2030 MAIN STREET, SUITE 1300, IRVINE, CA, 92614, US

(73) Assignee: Sunny General International Co., Ltd., Taipei County (TW)

(21) Appl. No.: 12/484,048

(22) Filed: Jun. 12, 2009

(51) Int. Cl. B32B 1/02; B32B 5/16; B29C 47/06; B32B 3/30; B32B 1/08

(52) U.S. Cl. 428/35.8; 428/323; 428/328; 264/173.16; 428/172; 428/36.4

(57) ABSTRACT

The thermal management multi-layer film/sheet and hollow articles for the use with secondary battery, supercapacitor and battery pack as thermal management casings or sleeves achieve effective control of the temperature of the operating batteries/supercapacitors. The thermal management multi-layer film/sheet and hollow article structure comprises a laminate of a plurality of alternative metal, plastic, and adhesive layers. And the plastic and adhesive layers comprise of parent phase resin, heat conductive particles, and microencapsule-phase-change-material (MCPCM). The heat conductive particles enhances the thermal conductivity, the MCPCMs absorb heat while the batteries/supercapacitors are in discharging mode.

### FIELD OF THE INVENTION

The present invention relates generally to multi-layer thermally conductive, insulating and absorptive films, sheets, and hollow articles for casings of secondary batteries, supercapacitors and sleeves of secondary battery/supercapacitor packs. The multi-layer films, sheets, and articles are composed of alternative layers of metal and plastics with dispersed microencapsulated-phase-change-material (MCPCM) and heat-conductive particles to properly absorb and dissipate heat generated by high-power secondary batteries and battery/supercapacitor packs with a plurality of secondary batteries/supercapacitor during charging and discharging periods. The multi-layer films, sheets, and articles also can be used as phase change types of heat sink and/or insulator to protect secondary battery/supercapacitor from thermal impact caused by high-temperature environment. In the multi-layer films/sheets/hollow articles, some plastic layers may be replaced by adhesive layers or chemically modified plastic layers with strong adhesion strength in order to provide strong inter-layer adhesion strength.

### BACKGROUND OF THE INVENTION

The known microencapsulated-phase-change heat absorbing materials have been revealed in the invention of U.S. Pat. No. 5,224,356 ('356 Patent). A method of using base material comprising thermal energy absorbing material for cooling electronic components, such as integrate circuit and resist, is efficient in reducing the surface temperature to 65-80% of the maximum surface temperature. Paraffins and eutectic metals may be selected as phase-change-materials to obtain optimum thermal properties of different operating temperature.

Another conventional thermal management system for battery packs which consist of a plurality of secondary batteries is disclosed with reference to U.S. Pat. No. 7,270,910 ('910 Patent). One of the thermal management systems for cooling battery packs of cordless power tools comprises of a gel blanket with microencapsulated-phase-change-material(MCPCM). Referring to FIG. 12 of the '910 Patent, the thermal management system utilizes the latent heat of fusion of a phase change material embraced by the gel blanket to absorb the dissipating heat from battery. The gel blanket is comprised of plastic carrier and MCPCM. The advantages of the system are as follows: cooling without moving parts, dispersed phase fully contained within battery pack and does not require any extra air flow or heat sinking to the outside of the battery pack. It can be cycled thousands of times. But the disadvantages are as follows: insufficient thermal conductivity for heat dissipation into environment, slow production rate of the battery packs due to the batch-wise production nature of the gel-blanket, high cost and labor-intensive due to the injection-molding process of the gel-blanket. To improve the aforementioned disadvantages of the gel-blankets of battery packs, multi-layer films/sheets/hollow articles of this invention with metal layer and/or plastic layer with sufficient contents of heat conductive particles are used to improve thermal conductivity for more efficient heat dissipation into environment and for storing heat in the plastic layer dispersed with MCPCM. The making processes of the multi-layer films/sheets/hollow articles are typically co-extrusion and extrusion coating processes which are continuous production processes characterized of high production rate, and low labor cost.

However, while the thermal management multi-layer films and microencapsulated phase-change-materials (MCPCMs) of the noted U.S. Patents are well known in the industry, none of the aforementioned U.S. Patents is known as being directed to addressing the aforementioned thermal conductivity and processing problems associated with high-power secondary batteries and battery/supercapacitor packs.

In the teachings of Journal of Power Sources 99 (2001) 70-77, it is stated that secondary batteries such as lithium-ion batteries and nickel-metal hydride batteries generate heats during charging and discharging. The charging and discharging efficiencies as well as longevity of those batteries are dependent on battery temperature. Consequently, temperature control is important to those secondary batteries. It would therefore be of benefit to provide directly to the casings of secondary batteries/supercapacitor, as well as sleeves for battery/supercapacitor packs. A new multi-layer films/sheets/hollow articles with thermal management functionality of which having the following properties: effective and efficient conductance and absorption of heat away from secondary batteries/supercapacitor and high-power battery/supercapacitor packs with a plurality of secondary batteries/supercapacitor during charging and discharging, excellent interlayer adhesion regarding the multi-layer films/sheets/hollow articles themselves, and economic and continuous production processes.

The battery/supercapacitor packs composed of a plurality of secondary batteries/supercapacitor, with casings and/or sleeves made of the multi-layer films/sheets/hollow articles with thermal management function, would therefore inherit the benefits of prolonged battery/supercapacitor service life, better charging and discharging efficiency and stability as well as efficient and economical production of the battery/supercapacitor packs.

### SUMMARY OF INVENTION

The invention solves the problems and overcomes the drawbacks and deficiencies of prior art gel-blanket designs by providing the batteries/supercapacitors and battery/supercapacitor packs an improved thermal management multi-layer film/sheet/hollow article structure which enables better heat dissipation as well as simplified manufacturing process for secondary batteries/supercapacitors and battery/supercapacitor packs

The invention, which is especially directed for uses with secondary batteries/supercapacitors and battery/supercapacitor packs, as thermal management casings and sleeves, achieves the aforementioned exemplary objects by providing multi-layer films/sheets/hollow articles comprising metal layers, plastic layers and adhesive layer between metal layer and plastic layer or between two plastic layers. The thermal management multi-layer films/sheets/hollow articles structures of present invention comprise of a laminate of a plurality of alternative metal layers, plastic layers, and adhesive layers. And the major manufacturing process for the multi-layer films/sheets/hollow articles may be co-extrusion, cast co-extrusion, and extrusion coating of plastic/adhesives layers onto metal layer. Accordingly, metal layers may be consisted of nickel, copper, tungsten, molybdenum, aluminum, steel, silver, gold and other acceptable metal and metal alloys.

And the plastic layers and adhesive layers are composed of parent phase resin, heat conductive particles, and microencapsulated-phase-change-materials (MCPCMs). The MCPCMs and heat conductive particles are dispersed within parent phase resin of the plastic layer and adhesive layer uniformly by composite compounding process. And the parent phase resin of the plastic layers and adhesive layers could be extrusion grades of Acrylonitrile-Butadiene-Styrene (ABS), Cellophane (CEL), Cellulose nitrate (CN), Cellulose Acetate (CA), Low-density Polyethylene (LDPE), High-density polyethylene (HDPE), Oriented Polypropylene (OPP), lonomers (IO), Polyethylene terephthalate (PET), Polybutylene terephthalate (PBT), Polystyrene (PS), Polycarbonate (PC), Polysulfones (PSU), Polyethersulfones (PESU), Polyimides (PI), Polyetherimides (PEI), Polymethylmethacrylate (PMMA), Polyamides (PA-4, PA-6, PA-7, PA-11, PA-12, PA-(4,6), PA-(6,6), PA-(6,8), PA-(6,10), PA-(6,12)), Polytetrafluorothylene (PTFE) and other fluoropolymer, EVOH copolymers, EVA copolymers. Typical parent phase resins of adhesive layer are those sold under the trade names PLEXAR, BYNEL, ADMER, NOVATEC, CXA. The parent phase resin of the adhesive layer is characteristic in excellent adhesion between metal layer and plastic layer.

The parent phase resins of adhesion layer are used as extrusion grades in co-extrusion or coating operations to bond two dissimilar materials that otherwise would have poor adhesion to each other. So the thermal management multi-layer films/sheets/hollow articles of present invention could have unique adhesive properties about each type of material. For example, high-density polyethylene has poor adhesion to ethylene vinyl alcohol copolymers. By using the plexar (e.g., Plexar® 1000) as inter-adhesion-layer material as aforementioned, a multi-layer structure combining the properties of low oxygen permeability EVOH and stiffness HDPE can be created. The multi-layer structure can be produced in a variety of manufacturing processes. Also parent phase resins of plastic layer should have sufficient impermeability against exterior moisture, oxygen and interior electrolyte.

For the heat conductive particles dispersed in parent phase resin of the plastic layers and adhesive layers described above, heat conductive materials made of metal-element, or ceramics are of the main interest. The heat conductive particles are dispersed uniformly within aforementioned plastic layers. The major function of the heat conductive particles is to effectively transfer heat from the inner side of batteries/supercapacitors to their outside surroundings. In other words, the heat conductive particles increases the thermal conductivity of the plastic and adhesive layers. In order to achieve effective and efficient thermal conductivity, care must be taken when choosing the heat conductive particles with respect to their particle size, geometry, and synergistic effects of multiple heat conductive particles used.

Ideal materials for heat conductive particles could be chosen from metal and carbon elements such as silver coated copper powders, silver, nickel, aluminum, copper, tin powders, alloy metal powders, hydride-dehydrogenated titanium powders, stainless steel powders, graphite powders carbon black powders, carbonnanotubes (CNTs), diamond powders, nano-metal powders, spherical alumina powders, super fine spherical aluminum powders; and non-oxide powders such as aluminum nitride powders, hexagonal boron nitride powders, B₄C, GaP, InP, LaB₆, MoS₂, Si₃N₄, TaN, TiC, TiClXNX, TiN, WC, WC/Co, YbF₃ and the sintering body of aforementioned particle mixture.

Also the oxide powders such as Al₂O₃, Al(OH)₃, B₂O₃, BaCO₃, BaSO₄, BaTiO₃, CeO₂, CoFe₂O₄, Co_{0.5}Zn_{0.5}Fe₂O₄, CoO, Co₃O₄, CrO₃, CsH₂PO₄, CuO, Dy₂O₃, Er₂O₃, Eu₃O₃, Fe₂O₃, Fe₃O₄, Gd₂O₃, HfO₂, In₂O₃, In(OH)₃:SnO₂, La₂O₃, Li₄Ti₅O₁₂, MgAl₂O₄, MgO, Mg(OH)₂, Mn₂O₃, MoO₃, Nd₂O₃, NiFe₂O₄, Ni_{0.5}Zn_{0.5}Fe₂O₄, NiO, Ni₂O₃, Pr₆O₁₁, Sb₂O₃, SiO₂, Sm₂O₃, SnO₂, SrAl₁₂O₁₉, SrCO₃, SrFe₁₂O₁₉, Tb₄O₇, TiO₂, VO, V₂O₃, V₂O₅, WO₃, YAG, YAG/Ce, YAG/Nd, Y₂O₃, ZnFe₂O₄, ZnO, ZrO₂, ZrO₂/Y₂O₃, ZrO₂/CaO, ZrO₂/CeO₂; and other nano-scale metal powders like nano-grade zinc oxide, nano-grade silver, nano-grade gold, nano-grade magnetic powder; and the sintering body of aforementioned particle mixture could be applied.

The average diameter of heat conductive particles could be 500 microns to 1 micron, and the range of 250 microns to 5 microns is preferred.

For the microencapsulated-phase-change-materials (MCPCMs) dispersed throughout the parent phase resins, the MCPCMs take advantage of their latent heat of fusion to store the heat generated by secondary batteries/supercapacitors or battery/supercapacitor packs for later or subsequent dissipation . For example, heat released from discharging batteries/supercapacitors is absorbed by MCPCMs and cause MCPCMs to change phase from solid to liquid with the temperature kept constant at the melting temperature of the MCPCMs during the melting process. And the temperature of the discharging batteries/supercapacitors with the multi-layer films/sheets/hollow articles of present invention is kept at a relatively lower temperature compared with the temperature of discharging batteris without the multi-layer films/sheets/hollow articles of present invention. The thermal energy storage of MCPCMs mostly depends upon the core phase change material, such as paraffinic hydrocarbons. When phase-change occurs in a MCPCM, it requires an unusually high amount of energy. In the present invention, the selection of the MCPCM for a specific operating condition depends on the temperature of the heating or cooling cycle of the batteris/supercapacitors or battery/supercapacitor packs. But the phase change temperature of the MCPCM has its limits. For example, the phase change temperature of some pure paraffins occurs at temperatures ranging from sub-ambient temperature to greater than 60° C. The variation of phase-change temperature depends on the length of paraffin carbon chain and the purity. If the number of carbons in the chain is odd and/or the chain length is greater than 20 carbons, a portion of the latent heat is associated with secondary transitions that occur in the solid state. The MCPCM of the present invention adopts microencapsulation so as to separate the phase-change-material from its surroundings.

Microencapsulation prevents the selected phase-change-material from mixing with the surrounding media when it melts. The diameters of the MCPCMs range from 0.5 to 1,000 microns.

Suitable phase-change-material(PCM) encapsulated by the heat conductive encapsulation wall could be either organic or inorganic phase-change-materials. Organic PCMs like paraffin usually have a wide range of melting point. Inorganic PCMs are generally hydrated salt based materials which have a number of hydrous and anhydrous forms.

The PCMs that can benefit from stabilization in accordance with various embodiments of the invention include a variety of organic substances. Exemplary PCMs include hydrocarbons like straight chain alkanes, paraffinic hydrocarbons, branched-chain alkanes, unsaturated hydrocarbons, halogenated hydrocarbons, alicyclic hydrocarbons, and waxes, oils, fatty acids, fatty acid esters, dibasic acids, dibasic esters, 1-halides, primary alcohols, aromatic compounds, and the anhydrides like ethylene carbonate, polyhydric alcohols, 2,2-dimethyl-1,3-propanediol, 2-hydroxymethyl-2-methyl-1,3-propanediol, ethylene glycol, polyethylene gylcol, pentaerythritol, dipentaerythrital, pentaglycerine, tetramethylol ethane, neopentyl glycol, tetramethylol propane, monoaminopentaerythritol, diaminopentaerythritol, tris(hydroxvmethyl)acetic acid, and the polymers like polyethylene, polyethylene glycol, polypropylene, polypropylene glycol, polytetramethylene glycol, and the copolymers such as polyacrylate or poly(meth)acrylate with alkyl hydrocarbon side chain or with polyethylene glycol side chain and copolymers comprising polyethylene, polyethylene glycol, polypropylene, polypropylene glycol, or polytetramethylene glycol), and mixtures thereof. For the suitable paraffinic hydrocarbons as PCMs, this paraffinic hydrocarbons PCM can be n-octacosane, n-heptacosane, n-hexacosane, n-pentacosane, n-tetracosane, n-tricosane, n-docosane, n-heneicosane, n-eicosane, n-nonadecane, n-octadecane, n-heptadecane, n-hexadecane, n-pentadecane, n-tetradecane, n-tridecane and the mixture thereof. Inorganic PCMs could be the hydrated salt based materials which include one or more elements selected from the group consisting of Te, Se, Ge, Sb, Bi, Pb, Sn, As, S, Si, P, O and mixtures or alloys thereof.

And the PCM can be a mixture of two or more substances. By selecting two or more different substances and forming a mixture thereof, a temperature stabilizing range can be adjusted over a wide range for any desired application. According to some embodiments of the invention, a PCM may comprise of two or more substances as mentioned above.

The multi-layer films/sheets/hollow articles having thermal management function of the present invention comprises of alternative layers of metal, plastic, and adhesive layers ranging from one to twenty layers. And the adhesive layer is interposed between metal-plastic or plastic-plastic layers if necessary.

A typical film/sheet structure includes a five-layer structure, which comprises a plastic layer, an adhesive layer , a metal layer, an adhesive layer and a plastic layer, wherein the adhesive layers are interposed between the aforesaid metal or plastic layers. Another typical film structure is a nine-layer structure, which comprises another set of one metal or plastic layer and one adhesive layer adhered on both outer layers of the five-layer structure individually.

And any variation of the number and thickness of the layers of the metal , plastic , and adhesive layers can be made.

Although each layer of the multilayer article structure can be of different thickness, the thickness of each layer of the multilayer article structure is preferably at least 5 microns and preferably up to about 10,000 microns. More preferably, the thickness of the multilayer article structures is less than about 20,000 micron. The thickness of the adhesive layer may vary, but is generally in the range of about 1 micron to about 50 microns. Preferably the thickness of the adhesive layer is between about 5 and 20 microns

Dispersing the heat conductive particles and MCPCMs into the parent phase resin of plastic and adhesive layers can be done by compounding process. The compounding process utilizes an extruder, two gravimetric feeders, a water bath, and a pelletizer. Typically, the extruder has a co-rotating intermeshing twin screws with 5˜15 zones. The oven dried parent phase resin/polymer of plastic or adhesive layers was introduced into the front zone of the extruder and melted by the co-rotating intermeshing twin screws. Two side stuffers located in the middle zone of the extruder were utilized to introduce heat conductive particles and MCPCMs into the parent phase resin/polymer melt.

Gravimetric feeders were used to accurately control the amount of heat conductive particles and MCPCMs added into the extruder. After the melting of the resin/polymer, which dispersed with heat conductive particles and MCPCMs, and passing through the rear zone of the extruder, the resin/polymer strands entered into water bath and were solidified. The solidified resin/polymer strands then passes through the pelletizer that produce nominally 2˜4 mm-long pellets. After the compounding process, the palletized composite resin (parent phase resin of the plastic or adhesive layer dispersed with heat conductive particles and/or MCPCMs) were dried and stored in moisture barrier bags prior to co-extrusion process or extrusion coating process.

The structures of the multi-layer films, sheets, and hollow articles can be categorized into 4 groups, according to their fabricating methods: 1. PPP (Plastic-Plastic-Plastic) and PAP (Plastic-Adhesive-Plastic) multi-layer films and sheets. 2. PPP (Plastic-Plastic-Plastic) and PAP (Plastic-Adhesive-Plastic) multi-layer articles with hollow profiles. 3. PMP (Plastic-Metal-Plastic) and PAMAP (Plastic-Adhesive-Metal-Adhesive-Plastic) multi-layer films and sheets. 4. PMP (Plastic-Metal-Plastic) and PAMAP (Plastic-Adhesive-Metal-Adhesive-Plastic) multi-layer articles with hollow profiles.

The apparatus and process disclosed in prior art provided the methods for fabricating PPP (Plastic-Plastic-Plastic) and PAP (Plastic-Adhesive-Plastic) multi-layer films and sheets. As stated in those teachings, co-extrusion was the process for fabricating PPP (Plastic-Plastic-Plastic) and PAP (Plastic-Adhesive-Plastic) multi-layer films and sheets. Extruders, including main extruders and co-extruders were used to supply compounded polymer melt streams into feed block by feeding devices such as gear pumps as well as control valves capable of controlling melt stream flow rate. After receiving the melt streams from the heat plastifying extruders through the inlet ports, the feed block passed the melt streams to a mechanical manipulating section within the feed block, where the original streams were combined into a multi-layer stream having the desired number and arrangement of layers. The multi-layer stream was then passed to an multi-manifold extrusion die apparatus, where optional melt streams from additional extruders joined the multi-layer melt stream from the feed block. The die apparatus then combined all melt streams into the final multi-layer stream. Elongation and deformation of the final melt stream from annular cross-section, coming from the feed block, to flat cross-section of uniform thickness of each layer also took place inside the die apparatus. Consequently, the final multi-layer stream was extruded out of the die slot. The desired thickness associated with each layer could be manifested by flow rate of each related melt stream and clearance between mandrel and sleeve of the channels inside the die apparatus. The multilayer stream exited from the die slot was further quenched into solid state by chill rolls and formed the multi-layer films or sheets of PPP and PAP types. Depending on the alternative designs of the cross-section shape and area of the die slot, any desired configuration of the multi-layer films or sheets could be extruded. The desired configuration of the multi-layer films and sheets could be specified with width, thickness, flat surface, extended surfaces such as fins, and heat conductive particles as well as MCPCM contents in each individual layer.

Co-extrusion apparatus and process for fabricating PPP and PAP types of multi-layer annular pipes were disclosed in prior art. The co-extrusion process started with main-extruders and co-extruders to heat plastify the compounded plastic pellets into melt streams. The melt streams were then fed to a die apparatus by feeding devices such as gear pumps as well as control valves capable of controlling melt stream flow rate through die inlet body. The die apparatus was comprised of a hollow die body having a bore, a mandrel positioned in the bore, spider means to support the mandrel in the bore, passageway means to form annular feed chamber, flow restriction means for reuniting melt streams which were disrupted by spider means and for balancing flow rates in the passageways, annular radial orifices for supplying additional melt streams to form the inner layers, and pressure balanced reservoir for balancing the flow of the melt streams. Inside the die apparatus, the melt streams from main extruder and co-extruders passed through the restriction means and passageway means to form an annular multi-layer melt stream. The annular multi-layer stream then flowed downstream to an annular discharge sleeve. The shape of the discharge sleeve would determine the shape of the final hollow profile of the multi-layer article. If the discharge sleeve was in annular shape, the final multi-layer article would be in pipe shape. If the discharge sleeve was in rectangular shape, the final multi-layer article would be rectangular column. After passing through the discharge sleeve, the multi-layer melt stream entered a sizing die in conjuction with a vacuum sizer to adjust the extruded multi-layer pipe or articles with hollow profile to its desired size. There was a cooling chamber inside the vacuum sizer, The cooling chamber functioned to solidify the multi-layer melt stream. The solidified multi-layer pipe or article passed further to a pulling device. The pulling device pulled the pipe or article from the discharge sleeve through the vacuum sizer. The multi-layer articles of hollow profile of PPP or PAP type could be specified by its cross-section shape and dimension, number of layers, individual layer thickness and total thickness, intermediate adhesive layer if bonding strength was insufficient, and heat conductive particles as well as MCPCM contents in each individual layer.

The apparatus and process disclosed in prior art described the extrusion coating of plastic layers onto metal layers to form the PMP and PAMAP multi-layer films and sheets. The process started with pretreatment operation of metal surfaces to ensure sufficient adhesion between surfaces of metal layer and coated plastic layer. Some optional pretreatment operations were also disclosed in prior art. The pretreatment operations in the teaching included cleaning, pickling, sand or bead blasting, and abrasion followed by rinsing and drying. After the pretreatment operation, the metal layer was coiled so as to enable continuous extrusion coating of plastic layers. The coiled metal layer was then released and moved by bridle rolls for continuous supply of in-line travel . Prior to extrusion coating of plastic layers, the traveling metal layer could be optionally treated by open-flame impingment or corona discharge to achieve desired surface-activation for better adhesion bonding of plastic layer to metal layer. PPP or PAP type of multi-layer melt stream was then extrusion coated onto the surface of the traveling metal sheet through die lip of the die apparatus. The co-extrusion of PPP or PAP type of multi-layer melt stream described earlier could be specified by desired width, thickness, number of layers, flat surface or extended surface. After the extrusion coating operation, the coated metal layer was passed through nip rolls to press firmly of plastic melt into contact with metal sheet. Consequently, the solidification of the coated plastic melt in a cooling chamber or quench water bath. Like the PPP or PAP types of multi-layer films or sheets, the cross-section shape and area of the die slot determined the width, thickness , flat surface, or extended surface of the extrusion coated plastic multi-layer. The arrangement of different plastic layers and adhesive layers was determined by the die apparatus and feed block of the co-extrusion apparatus. Adhesive layer was required in cases of poor adhesion between metal sheet and plastic layer or between plastic layer and plastic layer. Compounding of parent phase resin of plastic and adhesive layers with desired content of heat conductive particles and MCPCMs could be achieved in the main-extruders and co-extruders.

The apparatus and process disclosed in prior art described the steps for fabricating PMP and PAMAP multi-layer composite pipe. The process started with degreasing and pretreatment of metal strip surface, which was the same as the surface pre-treatment operation described previously in the PMP and PAMAP multi-layer sheet making process. Then, the inner layer or layers of PPP or PAP type was extruded or co-extruded, which was the same as the extrusion process described previously in the PPP and PAP multi-layer pipe making process. The surface-pretreated metal strip was then passed through a series of tube forming rolls, as described in the teachings of prior art. The metal strip was continuously shaped around the PPP or PAP type multi-layer pipe. Subsequently, seaming of the metal strip can be done by any welding operation, such as laser welding, arc welding or electric resistance welding, to form a seamed metal tube. The diameter of the seamed metal tube was then reduced by a “drawn down process” to bring the inner surface of the metal tube into contact with the outer surface of the PPP or PAP type multi-layer pipe. Next, bonding between both surfaces could be achieved by heating to the melting point of the inner PPP or PAP type multi-layer pipe. Up to this stage, a MP (metal-plastic) or MAP (metal-adhesive-plastic) type of multi-layer tube with outer metal layer and inner plastic or plastic-adhesive layers was obtained. Next, an extrusion-coating process disclosed in prior art was applied to coating plastic layer or plastic-adhesive layers onto the metal tube surface of the MP or MAP multi-layer tube. The MP or MAP multi-layer tube was passed through a series of die apparatus to be coated with adhesive layer and plastic layer sequentially, with hydraulic devices to move the MA or MAP multi-layer tube. A final step of quenching was used to solidify the plastic and adhesive layers. If necessary, additional metal layers, plastic layers , and adhesive layers could be added in the same way. Finally, the PMP or PAMAP type of multi-layer pipe was obtained. The method of fabricating multi-layer articles of hollow profiles of PMP and PAMAP type were the same as that of multi-layer PMP and PAMAP pipe. Except that the metal tube forming rolls were modified to forming rolls of desired cross-sectional profile such as rectangular and triangle, and the die apparatus for extrusion or co-extrusion of plastic and adhesive layers were modified to die apparatus of desired cross-sectional profile. The multi-layer articles of hollow profiles of PMP and PAMAP types could be specified by their cross-sectional shape and dimension, number of metal, plastic, and adhesive layers, individual layer thickness, total thickness, flat or extended surface, and heat conductive particles as well as MCPCM contents in each plastic or adhesive layer.

### BRIEF DESCRIPTION OF DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a perspective view of a conventional cylindrical lithium ion battery/supercapacitor construction coordinating with prior art.

FIGS. 2A and 2B are perspective views of a conventional prismatic lithium ion battery/supercapacitor construction coordinating with prior art.

FIG. 3 is an enlarged cross-sectional view of microencapsulated-phase-change-material (MCPCM).

FIG. 4 is an enlarged cross-sectional view of an exemplary embodiment of the multi-layer thermal management film/sheet according to the present invention.

FIG. 5 is an enlarged cross-sectional view of another exemplary embodiment of the multi-layer thermal management film/sheet according to the present invention.

FIG. 6A, FIG. 6B, and FIG. 6C are schematic illustrations of the multi-layer film structure containing bi-layer, tri-layer, and penta-layer packing according to the exemplary example of the present invention.

FIG. 7A, FIG. 7B, and FIG. 7C are perspective views of the distribution state of conductive particles, MCPCM and the mixture thereof within the plastic and adhesive layers part of multi-layer structures.

FIG. 8A and FIG. 8B are perspective views of the multi-layer film/sheet structure of PPP, PAP, PMP and PAMAP penta-layers structure.

FIG. 9A and FIG. 9B are perspective views of the rectangular multi-layer tube structure of PPP, PAP, PMP and PAMAP penta-layers structure.

FIG. 10A and FIG. 10B are perspective views of the cylindrical multi-layer tube structure of PPP, PAP, PMP and PAMAP penta-layers structure.

FIG. 11A and FIG. 11B are perspective views of the abnormal multi-layer hollow bore structure of PPP, PAP, PMP and PAMAP penta-layers structure.

FIG. 12A and FIG. 12B show the temperature profile of single battery without and with outer multi-layer film/sheet structure casing or sleeve.

FIG. 13A, FIG. 13B, and FIG. 13C show the block flow diagrams of the compounding process as well as the PPP and PAP multi-layer structure manufacturing processes.

FIG. 14A, FIG. 14B, FIG. 14C, and FIG. 14D show the block flow diagrams of the PMP and PAMAP multi-layer structure manufacturing processes.

### DETAlLED DESCRIPTION OF THE PREFERRED EMBODIMENTS

The following description of the preferred embodiment(s) is merely exemplary in nature and is in no way intended to limit the invention, its application, or uses.

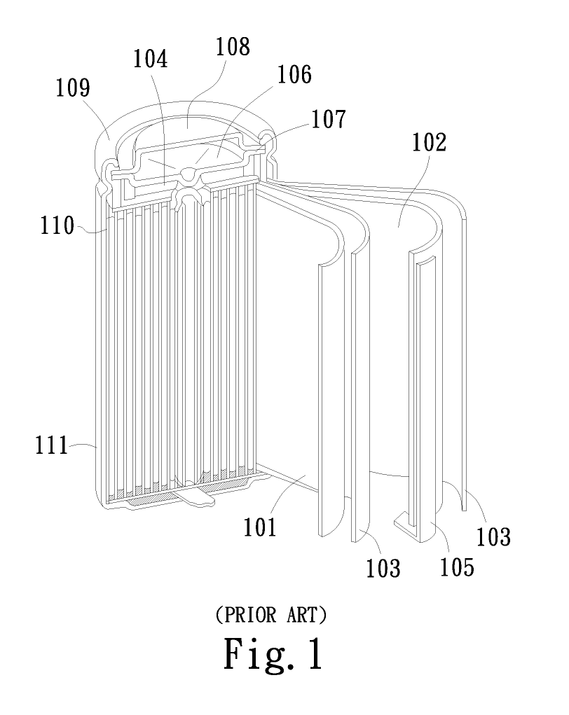

With reference to FIG. 1, the cylindrical lithium ion battery/supercapacitor used in the prior art is illustrated. The cylindrical lithium ion battery/supercapacitor ordinarily includes plural layers of cathode layers 101, anode layers 102 and the separator layers 103 between each couple of a cathode layer 101 and a anode layer 102. The end of the cathode layers 101 and anode layers 102 connecting to the cathode lead 104 and anode lead 105, and other parts of the cell contain the conventional cylindrical lithium ion battery/supercapacitor components like the safety vent 106 allowing gas to escape, the positive temperature coefficient resistor (PTC) 107, the top cover 108, the gasket 109, the insulator 110, and the casing 111 to prevent to the leakage of electrolyte and the invasion of outer interference. As shown in FIG. 1, the thermal energy generated by the whole battery/supercapacitor modules is conducted to the surface of the insulator 110 and the casing during the process of the battery/supercapacitor discharging and charging.

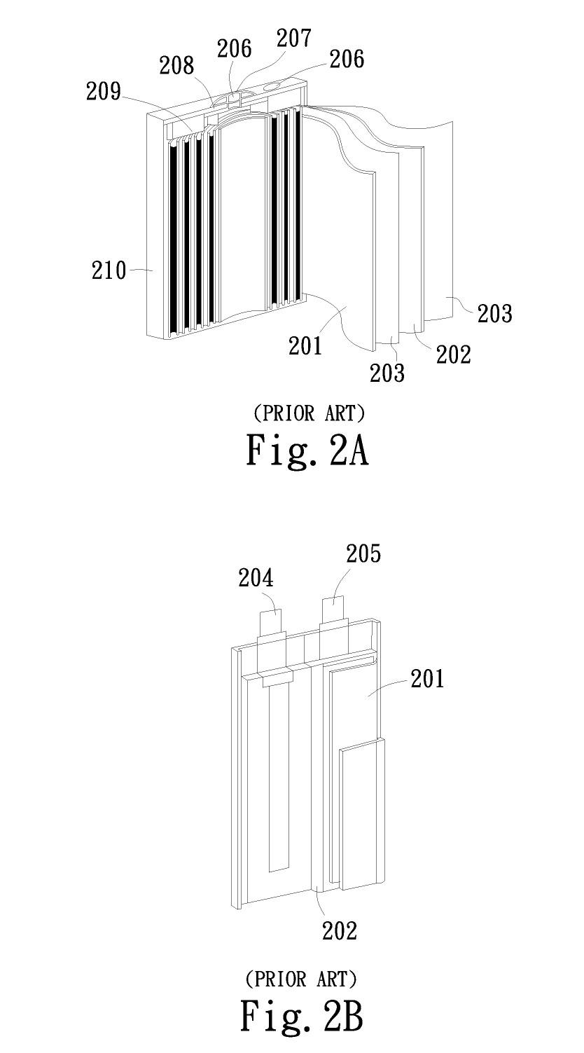

With reference to FIG. 2, the prismatic lithium ion battery/supercapacitor used in prior art is illustrated. The prismatic lithium ion battery/supercapacitor ordinarily includes plural layers of cathode layers 201, anode layers 202 and the separator layers 203 between each couple of a cathode layer 201 and a anode layer 202. And the electrode layers and separator layers 203 are overlapped following the order of one cathode layer 201, one separator layers 203, one anode layer 202,and another separator layers 203 to the desired battery/supercapacitor cells amounts. And the end of the cathode layers 201 and anode layers 202 connecting to the cathode lead 204 and anode lead 205. Other parts of the cell contain the conventional prismatic lithium ion battery/supercapacitor components like the safety vent 206 allowing gas to escape, the negative cap 207, the gasket 208, the insulator spacer 209, and the casing 210 to prevent to the leakage of electrolyte and the invasion of outer interference. As shown in FIG. 2, the heat generated by the whole battery/supercapacitor modules is conducted to the surface of the insulator spacer 209 and the casing 210 during the process of the battery/supercapacitor discharging and charging.

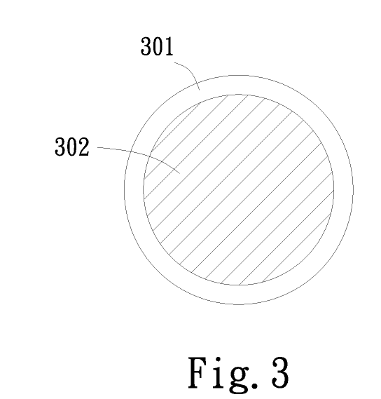

FIG. 3 discloses the cross section structure of microencapsulated-phase-change-material (MCPCM) wherein the phase-change-material (PCM) 302 was encapsulated by the heat conductive shell 301. The PCM 302 permits the storage of heat for later or subsequent dissipation. The heat released from discharging battery/supercapacitor is absorbed by the MCPCM and result in the phase change of PCM 302 from solid state to liquid state. The heat stored in PCM 302 could be appropriately dissipated to its surrounding during relaxation time. The thermal energy storage of PCM 302 mostly depends upon the latent heat of fusion. The PCM 302 of the present invention adopts microencapsulation as the process of separating a selected material from its surroundings by the outer shell 301. The microencapsulation of PCM 302 relies upon the use of a capsule wall like outer shell 301 that is designed to last for a long service life. The diameters of the heat conductive particle can range from 0.5 to 1,000 microns. And the outer shell 301 is composed of the metal, ceramic or polymer materials.

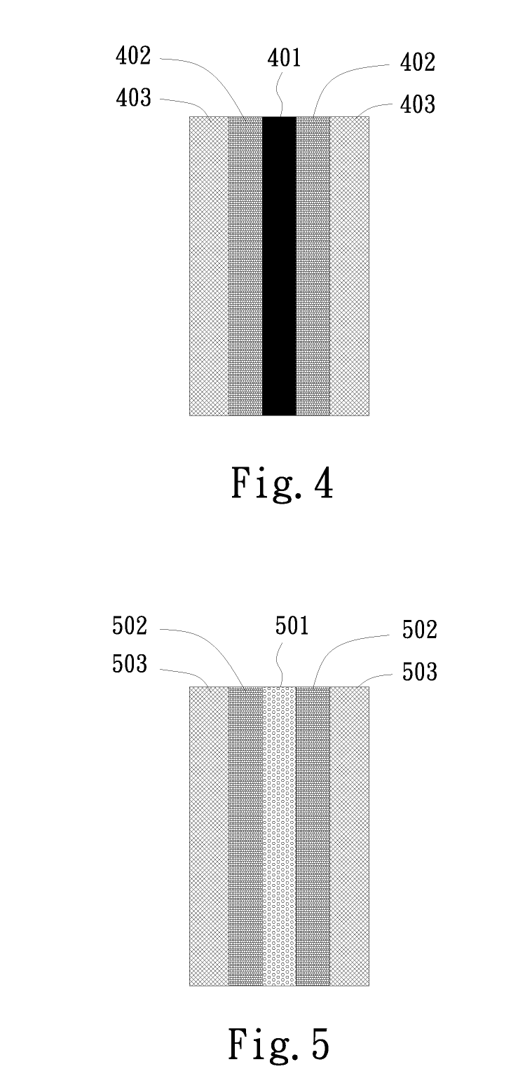

Referring to FIG. 4 and FIG. 5 of the present invention, FIG. 4 and FIG. 5 show two preferred embodiments of the present invention. FIG. 4 shows the preferred five-layer structure of the thermal management type multi-layer film/sheet of the present invention which comprises one metal layer 401, two plastic layers 403 and two adhesive layers 402. And the adhesive layer is interposed between metal layer 401 and plastic layer 403. The multi-layer film/sheet of the present invention can have a variety of structures as long as there is an adhesive layer between pair of plastic layers. A typical film/sheet structure includes a five-layer structure as the preferred embodiments of FIG. 4. The middle metal layer 401 provides the necessary strength and thermal conductance to the thermal management type multi-layer film/sheet. And the metal layer may be consisted of nickel, copper, tungsten, molybdenum, aluminum, steel, silver, gold and other acceptable metal foils. The composition of the adhesive layer 402 of the present invention can be the blends of an alkyl ester copolymer and a modified polyolefin, and blends thereof. And the heat conductive particles as well as MCPCMs are also dispersed uniformly within the adhesive layer 402 to absorb the heat generated from operating batteries/supercapacitors. And the two outer plastic layers 403 on both sides of the multi-layer film structure could be polyethylene, polyethylene copolymers, polyamides, EVOH copolymers, EVA copolymers, polypropylene, HDPE, LDPE, LLDPE or other applicable materials. Each layer of the multilayer film/sheet structure can be of different thickness, and the thickness of each layer in the multilayer film/sheet structure is preferably at least 0.05 microns and preferably up to about 250 microns. More preferably, the thickness of the multilayer film structures is less than about 50 microns. The thickness of the adhesive layer 402 may vary, but is generally in the range of about 0.05 microns to about 12 microns. Preferably the thickness of the adhesive layer is between about 0.05 and 1.0 microns, and most preferably between about 0.25 microns and 0.8 microns. FIG. 5 shows another preferred five-layer structure of the thermal management type multi-layer film/sheet of the present invention comprises of one middle plastic layer 501, two outer plastic layers 503 and two adhesive layers 502. And the adhesive layer is interposed between the middle plastic layer 501 and the outer plastic layer 503. The five-layer multi-layer film/sheet can have a variety of materials for each layer. The middle plastic layer 501 provides the necessary strength and thermal conductance to the thermal management type multi-layer film/sheet. And the composition of the adhesive layer 502 of the present invention can be the blends of an alkyl ester copolymer and a modified polyolefin, and blends thereof. And the heat conductive particles as well as MCPCMs are also dispersed uniformly within the two adhesive layers 502, middle plastic layer 501, and the two outer plastic layers 503 to absorb the heat generated from operating batteries/supercapacitors. And the two outer plastic layers 503 on both sides of the multi-layer film could be polyethylene, polyethylene copolymers, polyamides, EVOH copolymers, EVA copolymers, polypropylene, HDPE, LDPE, LLDPE or other applicable materials. Each layer of the multilayer films structure can be of different thickness, and the thickness of each layer in the multilayer films structure is preferably at least 0.05 microns and preferably up to about 250 microns. More preferably, the thickness of the multilayer film/sheet structures is less than about 50 microns. The thickness of the adhesive layer 402 may vary, but is generally in the range of about 0.05 microns to about 12 microns. Preferably the thickness of the adhesive layer is between about 0.05 and 1.0 microns, and most preferably between about 0.25 microns and 0.8 microns.

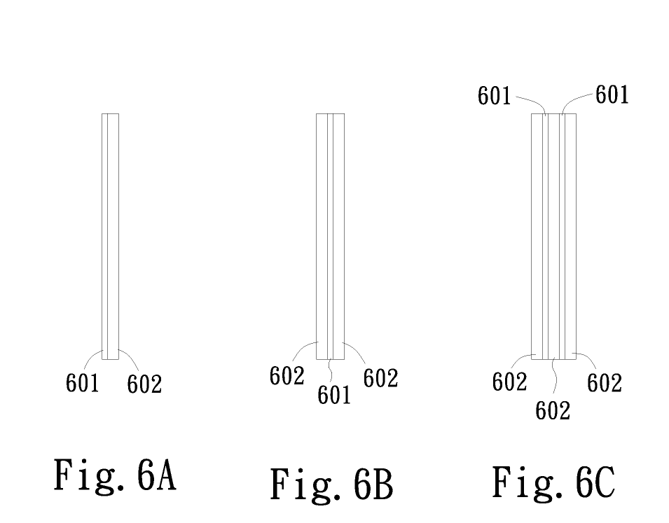

FIG. 6 discloses the preferred embodiments of bi-layer, tri-layer, and penta-layer structures of the thermal management type multi-layer film/sheet of the present invention. The thermal management type multi-layer film/sheet of the present invention comprises at least one metal or plastic layer 602 and at least one adhesive layer 601. And the adhesive layer 601 is interposed between pairs of metal or plastic layers 602. As shown in FIG. 6, the multi-layer structure can be an adhesive layer 601 coupled with one metal or plastic layer 602, or an adhesive layer 601 coupled with two metal or plastic layers 602 on the both sides of the adhesive layer 601. And the multi-layer structure can be extended to the penta-layer structure which comprises of two adhesive layers 601 coupled with three metal or plastic layers 602, and the adhesive layer 601 is interposed between pairs of metal or plastic layer 602. Also the bi-layer, tri-layer, and penta-layer structure can be adhered to both sides of the middle layer, like the middle plastic layer 501 of FIG. 5, to form different multi-layer structures of the thermal management type multi-layer film/sheet of the present invention.

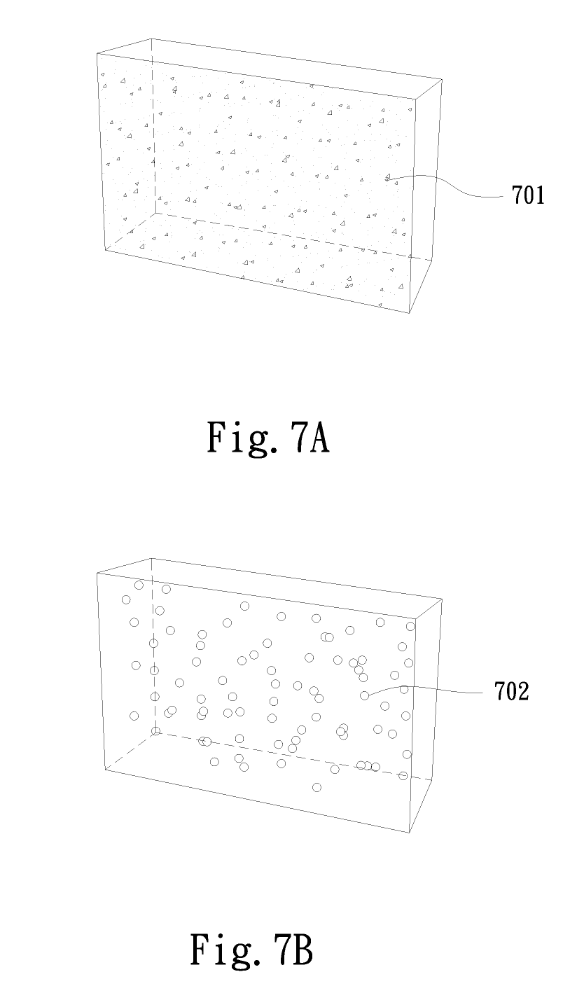

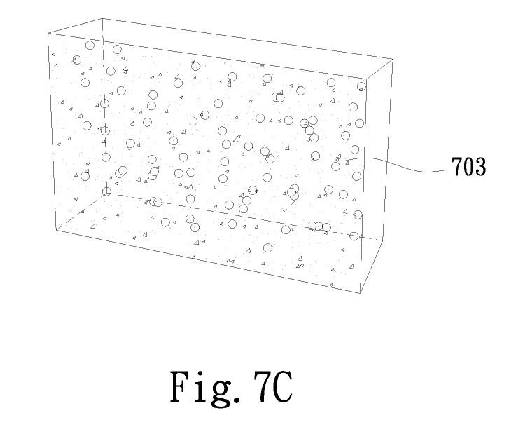

Referring to FIGS. 7A, 7B and 7C of the present invention, FIGS. 7A, 7B and 7C display the distribution state of conductive particles 701, MCPCM 702 and the mixture 703 thereof within the plastic and adhesive layers part of multi-layer structures. In FIGS. 7A and 7B, conductive particles 701 and MCPCM particles 702 were composed of aforementioned compounds and well distributed inside of the multi-layer structures. FIG. 7C shows the homogeneously mixed mixture 703 of conductive and MCPCM particles. As shown in FIG. 7C, the mixture 703 shows a random arrangement so that heat conducted from all direction can be absorbed and conducted uniformly. The homogeneous mixture of conductive particles 701, MCPCM 702, and parent phase resin of plastic and adhesive layers can be well achieved by the compounding process of the present invention.

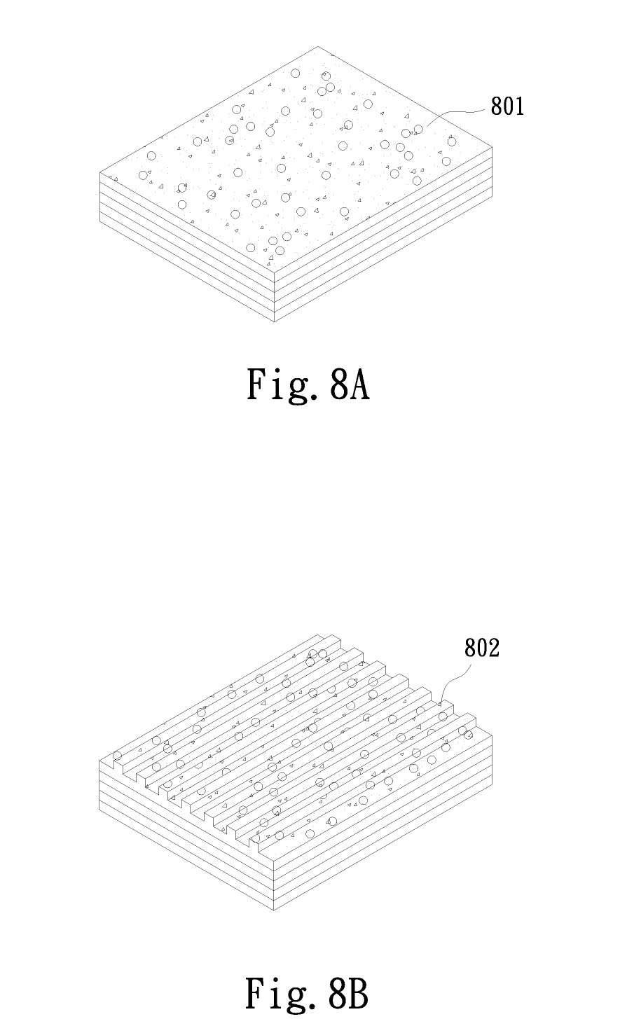

Referring to FIGS. 8A and 8B of the present invention, FIGS. 8A and 8B show the basic multi-layer film structure of PPP, PAP, PMP and PAMAP penta-layer structure. The surface of the penta-layer structure 801 shows a plastic layer containing conductive particles and MCPCM particles. And the second to the fourth layer can be either metal layer, plastic layer or adhesive layer, which all of these were made by the manufacturing process above mentioned. The bottom layer can be the same as the surface layer or the other internal layers. FIGS. 8A and 8B show film and sheet structures which are two of the possible embodiments of the present invention. FIG. 8B shows additional plural extending fins 802 on the surface of the penta-layer structure, the profile of fins 802 can be designed in different shape and dimension and can be applied to the internal layers of multi-layer film and sheet structure as well.

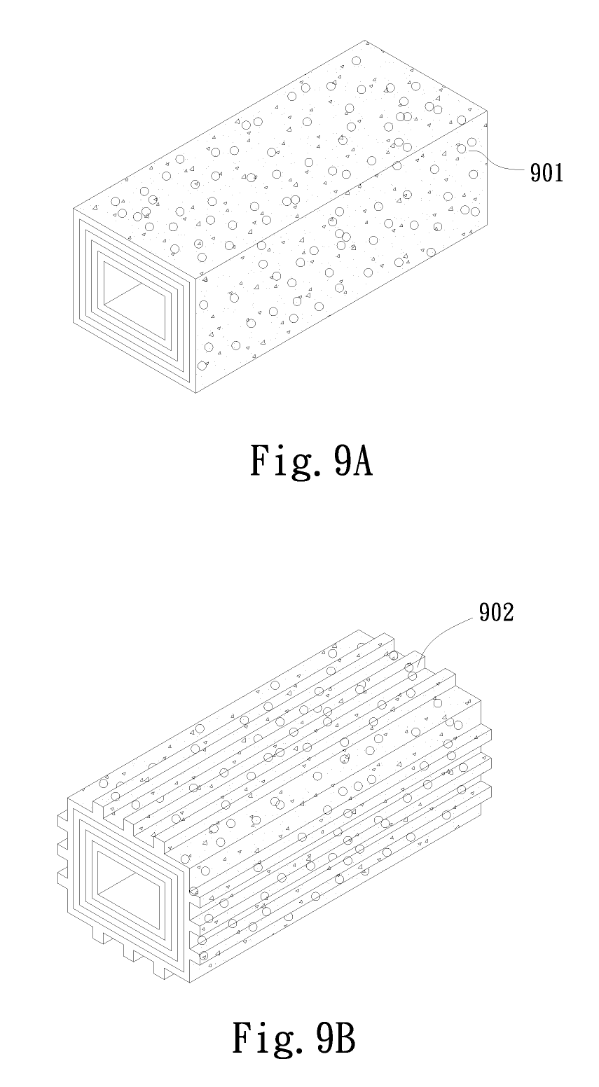

Referring to FIGS. 9A and 9B of the present invention, FIGS. 9A and 9B show the rectangular multi-layer tube structure 901 of PPP, PAP, PMP and PAMAP penta-layer structure. As above mentioned, each layer of the rectangular multi-layer tube structure 901 can be replace with different materials and extending fins 902 can be added in response to different demand especially as extension of surface area for convective heat transfer purposes. In the center of the rectangular multi-layer tube structure 901, there is a hollow bore so that prismatic types of batteries or supercapacitors as shown in FIG. 2 with proper size and profile can be inserted directly. The bottom part of the rectangular multi-layer tube structure 901 can be open or close. As battery or supercapacitor been inserted into the rectangular multi-layer tube structure 901, the temperature elevation of the charging/discharging battery and supercapacitor can be well controlled.

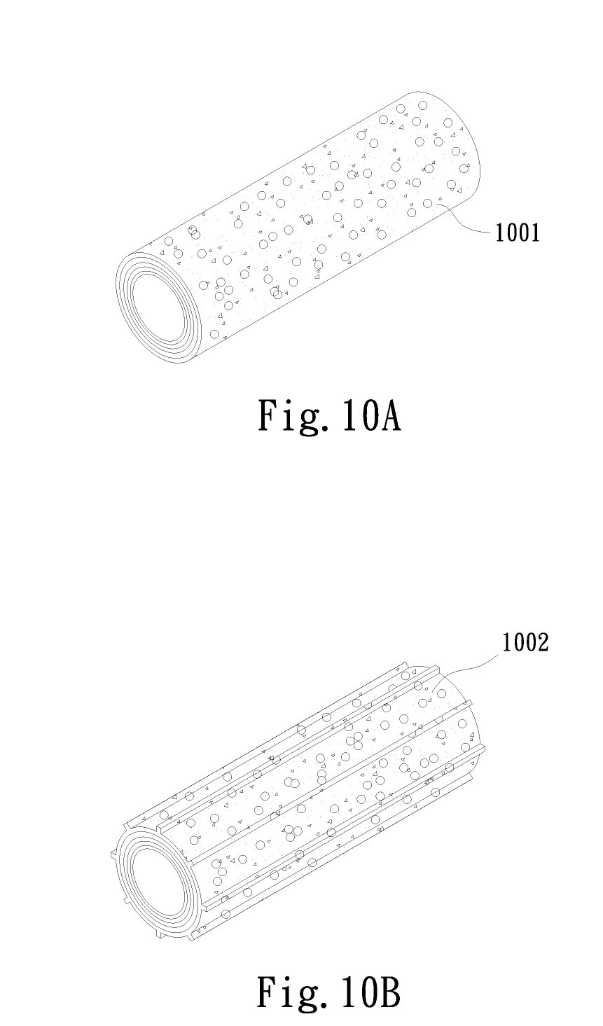

FIGS. 10A and 10B are another possible cylindrical multi-layer tube structure embodiment of the present invention. FIGS. 10A and 10B show the cylindrical multi-layer tube structure 1001 of PPP, PAP, PMP and PAMAP penta-layer structure. As above mentioned, each layer of the cylindrical multi-layer tube structure 1001 can be replace with different materials and extending fins 1002 can be added in response to different demand especially as extension of surface area for convective heat transfer purposes. Cylinder type batteries as shown in FIG. 1 can be directly insert into the cylindrical multi-layer tube structure 1001 with matched size. However, it doesn't limit the usage of cylindrical multi-layer tube structure 1001 within cylinder center hollow bore. As the extending fins 1002 profiles can be modified depending on different demand, the center hollow bore of cylindrical multi-layer tube structure 1001 can be designed as square or other profiles if necessary. And certainly the fin size and profile can be adjusted in accordance with the co-extrusion manufacturing process of the present invention.

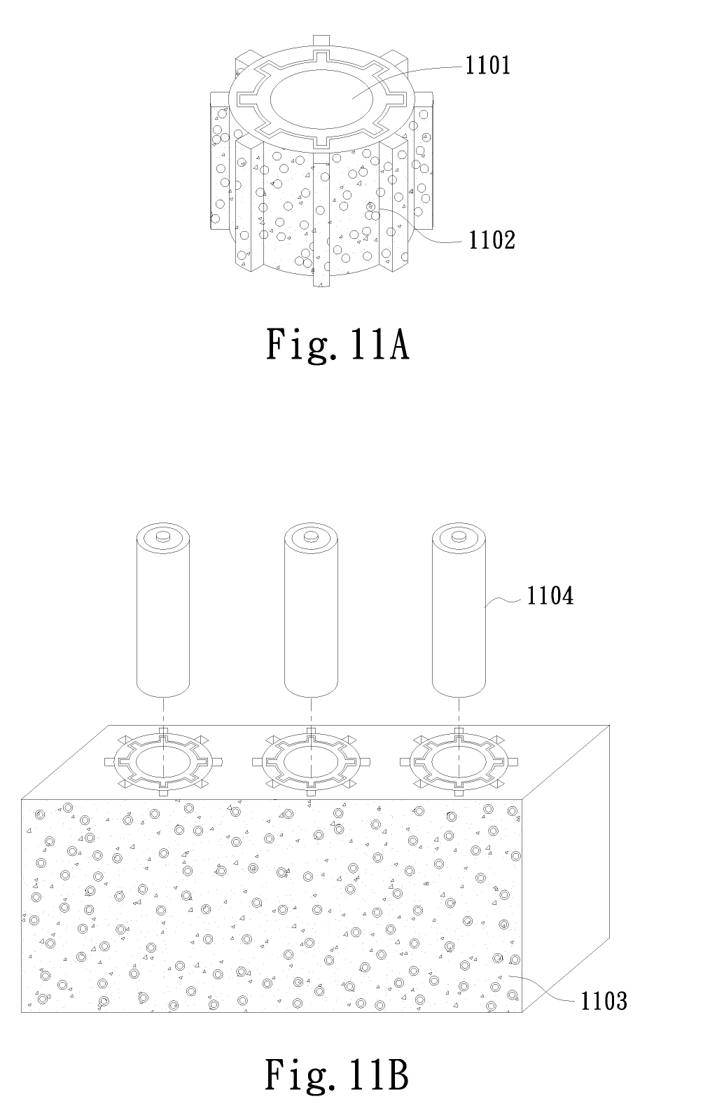

FIGS. 11A and 11B show an abnormal multi-layer hollow bore structure. In FIG. 11A, the center hollow bore 1101 can be inserted a cylinder battery/supercapacitor with matched size without any complicated process. FIG. 11A also shows that the multi-layer structure may have different profiles and fins 1102 from inner layers to outer layers. In FIG. 11B, desired object 1104 like batteries or supercapacitors can be inserted into the hollow bore 1101. The multi-layer sleeve is very flexible in hollow bore amount, shape, dimension and multi-layer composition. According to FIG. 11B, it disclosures a multi-layer sleeve structure preferred embodiment which may adopt three batteries or supercapacitors. As shown in FIG. 11B, the structure contains three hollow bores which are able to be inserted with different desired object 1104. After all the batteries or supercapacitors been inserted, the multi-layer sleeve fully encompasses individual battery/supercapacitor and the thermal energy generated by charging/discharging batteries/supercapacitos can be absorbed and dissipated effectively. Therefore the operation of battery/supercapacitor pack can be maintained in a stable and cool circumstance.

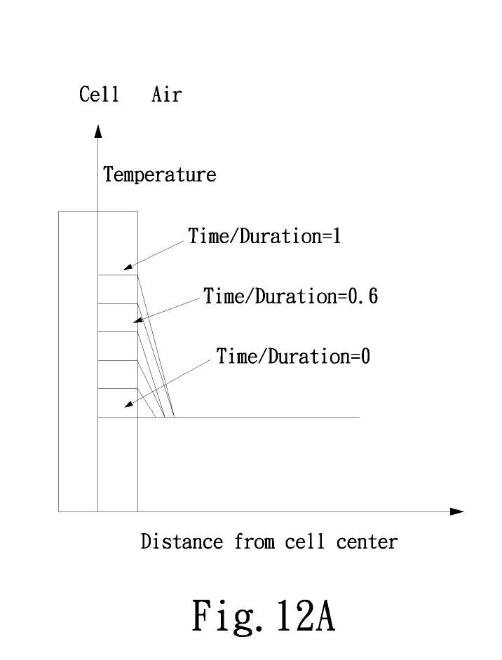

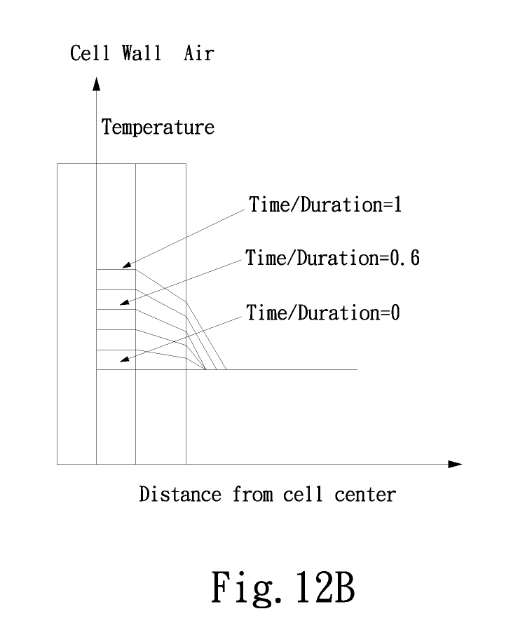

With reference to FIGS. 12A and 12B, FIG. 12A shows the temperature profile of a single battery/supercapacitor without outer multi-layer structure casing or sleeve. It is obvious that the maximum temperature at time/duration=1 in FIG. 12A is higher than the temperature at time/duration=1 in FIG. 12B. As a result, single battery/supercapacitor or plural batteries/supercapacitors accompanying outer multi-layer structure casing or sleeve like the present invention can be maintained at reduced maximum operation temperature.

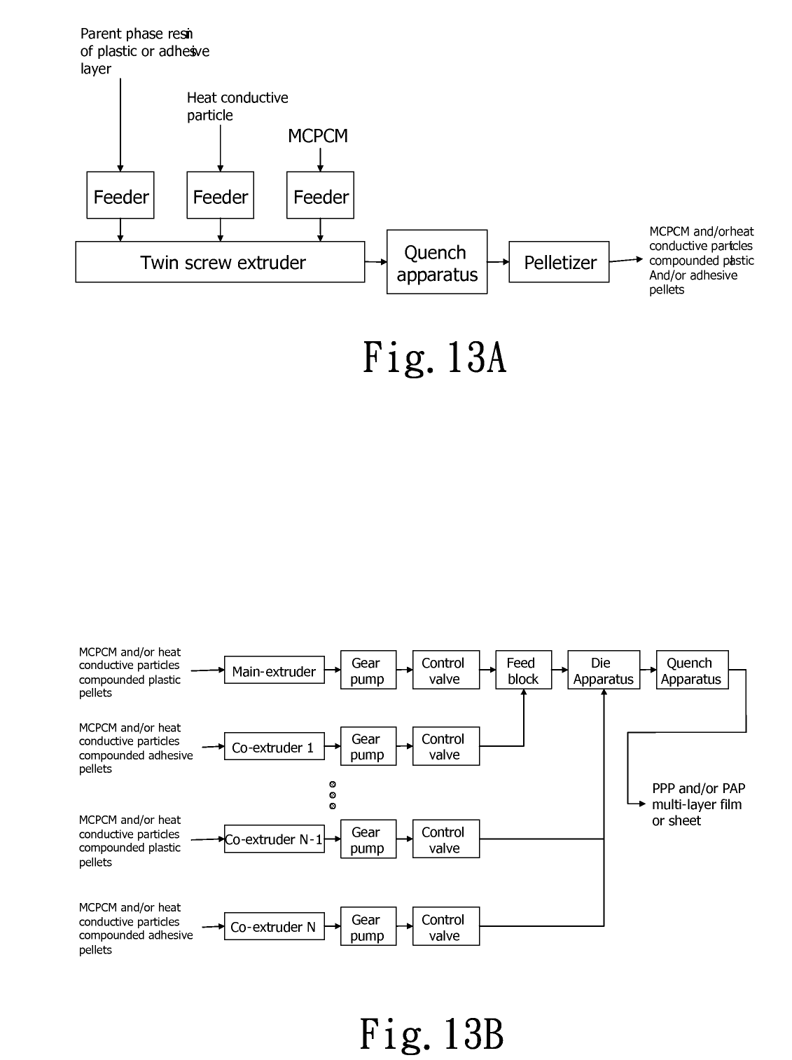

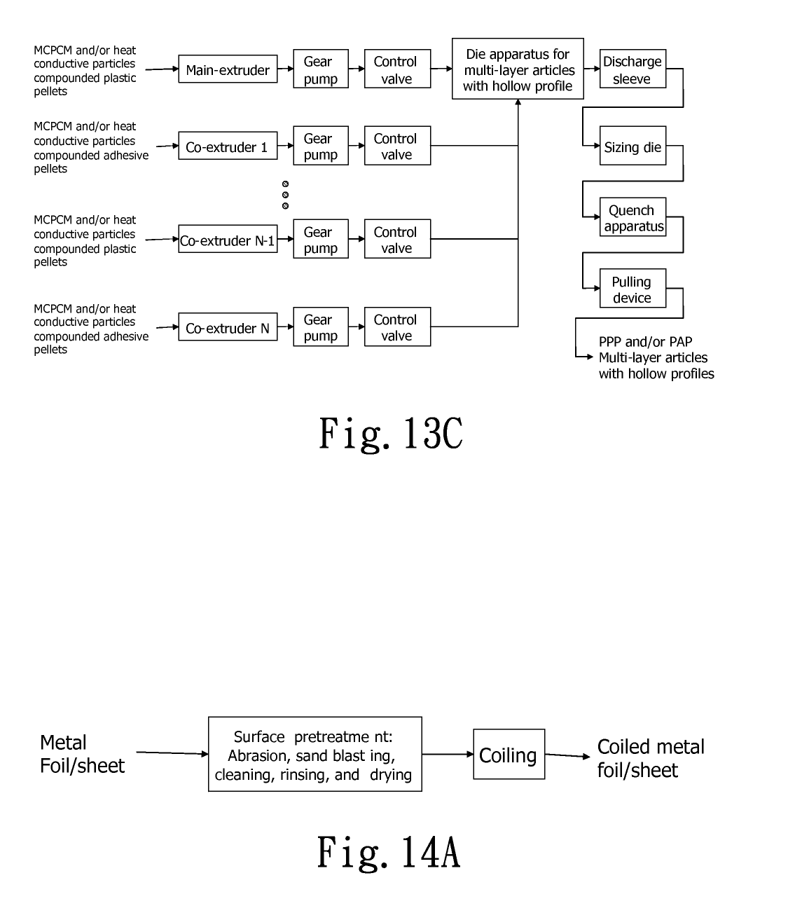

With reference to FIGS. 13A, 13B and 13C, the whole PPP and PAP multi-layer structure manufacturing process is revealed. FIG. 13A shows the block flow diagram of compounding process to manufacture the homogeneous plastic or adhesive pellets with parent phase resin, heat conductive particles and MCPCM particles. The twin screw extruder adopted here and the processing thereof are well-known for the ordinary skill people in the polymer process art field so the detail description is omitted herein. The polymer melt of parent phase resin, conductive particles and MCPCM particles is extruded into a quench apparatus and then formed plastic pellets through the pelletizer. Refer to FIG. 13B, the compounded pellets are fed into main extruder and plural co-extruders. The arrangement of main extruder and plural co-extruders depends on desired number of layer of the PPP and PAP structure. For example, in a penta-layer PAPAP structure manufacturing process, the designed plastic layer pellets are fed into main extruder, third and fifth co-extruder, and the designed adhesive layer pellets are fed into second and fourth co-extruder. By the co-extrusion of main extruder and four co-extruders, the penta-layer film/sheet can be produced through well-known ordinary polymer co-extrusion process, so the detail description is omitted herein. Refer to FIG. 13C , the multi-layer articles with hollow profiles can be manufactured with plural extruders, discharge sleeve, sizing die and pulling device, all these co-extrusion process and apparatus are well-known for the person in the art and the detail description is omitted herein.

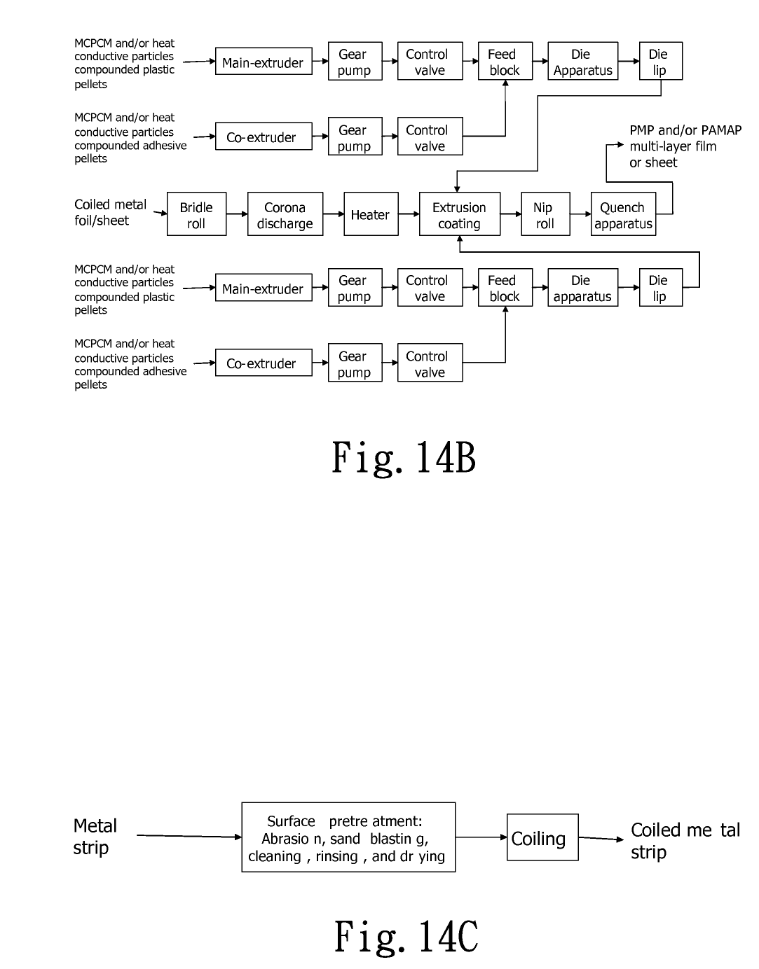

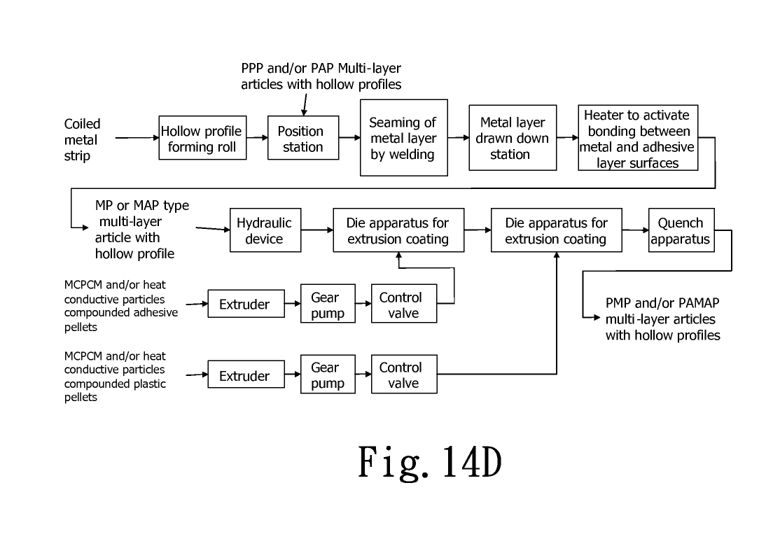

With reference to FIGS. 14A, 14B, 14C and 14D, the whole PMP and PAMAP multi-layer structure manufacturing process is revealed. Referring to FIGS. 14A and 14C, the block flow diagram of the manufacturing process of the metal layer in the PMP and PAMAP are illustrated. The metal foil/sheet/strip goes through surface pretreatment, abrasion, sand blasting, cleaning, rising and drying processes. After the surface pretreatment steps, the treated metal foil/sheet/strip will be coiled to form a coiled metal foil/sheet/strip. In the following unit operations, as shown in FIGS. 14B and 14D, the coiled metal foil/sheet/strip will be combined or laminated with plastic and adhesive layers by co-extrusion and/or extrusion coating. For instance, in the process illustrated in FIG. 14B, coiled metal foil/sheet goes through bridle roll, corona discharge and heater to receive following extrusion coating. The designed plastic and adhesive layer will be coated on both sides of metal foil/sheet and formed desired PMP and PAMAP multi-layer film/sheet. The above process is ordinary polymer process procedure and well-known for the person in the art, so the detail description is omitted herein.

### EXAMPLE 1

Example 1 (Refer to FIG. 11A) discloses a preferred example of the multi-layer sleeves. The MAP annular tube sleeve for 18650 Li-ion battery/supercapacitor contains three different layers. The inner layer is composed of aluminum-magnesium (Al—Mg) metal alloy and the layer thickness is 0.3 mm. The extended fin is 2.5 mm in length and 1.0 mm in width, and the distance between fin edges is 2.0 mm. The thermal conductivity of the metal alloy layer is 200 W·m⁻¹·K⁻¹ and the inside diameter of the metal layer (hollow bore diameter) is 21 mm. The middle adhesive layer is composed of ADMER QF551E (40%) , AlN (59.9%) and carbon-nano-tube (0.1%). And the thickness of middle adhesive layer is 50 micron. The thermal conductivity of middle adhesive layer is 10 W·m⁻¹·K⁻¹. The outer plastic layer is composed of polyethylene (PE)(40%)+AlN (10%)+MPCM 43D. The layer thickness is 3 mm, and the extended fin is 2.0 mm in length and 1.0 mm in width, The distance between each fin edge is 2.0 mm. The thermal conductivity of outer plastic layer is 10 W·m⁻¹·K⁻¹ (ASTM F433 Guarded heat flow meter method) and latent heat of fusion is 70 KJ·Kg⁻¹ at 43° C. (Determined by a differential scanning calorimeter Perkin-Elmer DSC-7, USA, equipped with DSC-7 kinetic software).The brush-on conductive-gel layer is composed of DX 2000 polyol resin (40%)+AlN (59.9%)+carbon-nano-tube (0.1%). The PAMAP rectangular tube is made by co-extrusion coating process. And the sleeve making process bases on follow-up steps. The first step is to knife cut the manufactured tube into desired dimension (in this example, for 18650 Lithium-ion cylindrical battery/supercapacitor, the desired length is 65 mm). The second step is to brush on a thin layer of conductive-gel onto the surface of the 18650 lithium-ion cylindrical battery/supercapacitor. The third step is to insert the 18650 Lithium-ion cylindrical battery/supercapacitor into the bore of the sleeve. After the above process, the battery/supercapacitor can be control within proper temperature range by the multi-layer sleeve of the present invention.

### EXAMPLE 2

Example 2 (Refer to FIG. 9B) discloses a preferred example of the multi-layer PPP type rectangular tube with hollow bore to be used as thermal management sleeve of prismatic type Li-ion secondary battery/supercapacitor which is consisted of the following layer structure and compositions. The parent phase resin is EVA copolymer (DuPont™ Elvax® CM555), which consists of 35 % of the total weight. The dispersed phase consists of 10% AlN (Average particle size of AlN is 10˜20 micron), and 55% of MPCM 43D (Average particle size 10˜20 micron and phase change temperature at 43° C.). The inside hollow bore dimension is 10 millimeters in width and 100 millimeter in length. The layer thickness is 8 millimeter. The outer surface consists of several arrays of fin type extended surface with 2.5 millimeter of fin length, 1.0 millimeter of fin width, and the distance between adjacent fin edges is 2.0 millimeter. The measured thermal conductivity is 0.4 W·m⁻¹·K⁻¹ (ASTM F433 Guarded heat flow meter method) and the latent heat of fusion is 90 KJ·Kg⁻¹ at 43° C. (Determined by a differential scanning calorimeter Perkin-Elmer DSC-7, USA, equipped with DSC-7 kinetic software).

### EXAMPLE 3

Example 3 (Refer to FIG. 8A) discloses a preferred example of tri-layer PPP type flat sheet to be used as thermal management casing for prismatic type Li-ion secondary battery/supercapacitor which is consisted of the following layer structures and compositions: The inner (or the first) layer is a plastic layer with 35% of polyethylene (PE), 64.9% of hexagonal boron nitride (h-BN) (Sourcing from Momentive Performance Materials Inc.), and 0.1% of CNT. The average layer thickness is 50 microns. The sandwiched (or the second) layer is an adhesive layer composed of 35% of BYNEL 21E533 (BYNEL is a registered trade mark of Du Pont Company) , 64.9% of h-BN , and 0.1% of CNT. The average layer thickness is 30 microns. The outer (or third) layer is a plastic layer with 35% of polybutylene terephthalate (PBT), 15% of h-BN and 40% of MPCM 43D. The average layer thickness is 2.5 millimeters. The average thermal conductivity of the tri-layer sheet is 1.0 W·m⁻¹·K⁻¹. The latent heat of fusion is 85 KJ·Kg⁻¹ at 43° C.

### EXAMPLE 4

Example 4 (Refer to FIG. 10A) discloses a preferred example of PAMAP type penta-layer hollow tube to be used as thermal management casing of 18650 cylinder type Li-ion secondary battery/supercapacitor which is consisted of the following layer structures and compositions: The inner (or first)layer is an plastic layer composed of 40% PBT, and 60% AlN, with 50 micron average layer thickness. The second (or intermediate) layer is an adhesive layer composed of 40% BYNEL 21E533 , 59.9% AlN , and 0.1% CNT, with 30 microns average layer thickness. The third layer is a steel layer with 100 microns average thickness. The fourth layer is an adhesive layer composed of 40% ADMER NF408E, 59.9% AlN, and 0.1% CNT. The average layer thickness is 30 microns. The fifth layer is a plastic layer composed of 40% PE, 10% AlN, and 50% MPCM 43D. The average layer thickness is 3 mm. The inside diameter of the hollow tube is 18 mm.The average thermal conductivity of the tetra-layer hollow tube is 1.0 W·m⁻¹·K⁻¹. The latent heat of fusion is 85 KJ·Kg⁻¹ at 43° C.

### EXAMPLE 5

Example 5 discloses a preferred example of MAP type tri-layer rectangular tube to be used as thermal management casing of 18650 prismatic type Li-ion secondary battery/supercapacitor which is consisted of the following layer structures and compositions: The inner (or first) layer is an steel layer, with 100 microns average layer thickness. The second (or intermediate) layer is an adhesive layer composed of 40% ADMER NF408E, 59.9% AlN , and 0.1% CNT, with 50 microns average layer thickness. The third layer is a plastic layer with 3 mm average thickness and composed of polyethylene (PE)(40%)+AlN (10%)+MPCM 43D with 3 mm layer thickness. The extended fins are formed on the outer surface of third layer.

### EXAMPLE 6

Example 6 (Refer to FIG. 10B) disclosures a preferred example of PAMAP type annular tube to be used as thermal management casing of 18650 cylinder type Li-ion secondary battery/supercapacitor which is consisted of the following layer structures and compositions: The inner (or first) layer is an aluminum-magnesium (Al—Mg) metal alloy and the layer thickness is 0.3 mm. The second (or intermediate) layer is an adhesive layer composed of ADMER QF551E (40%) , AlN (59.9%) and CNT (0.1%), with 50 microns average layer thickness. The third layer is a plastic layer with 3 mm average thickness and composed of polyethylene (PE)(40%)+AlN (10%)+MPCM 43D. The extended fins are formed from inner first layer.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A thermal management multi-layer film/sheet for the use with secondary battery and supercapacitor, comprising:
a plurality of the heat conductive particles;
a plurality of the microencapsulated-phase-change-material particles; and
at least one plastic layer including the said heat conductive particles and microencapsulated-phase-change-material particles dispersed uniformly within the said plastic layer;
wherein the said plastic layer has a laminate multi-layer film/sheet structure and each said plastic layer is overlapped in order with one another when the number of layer is more than one.

2. A thermal management multi-layer film/sheet according to claim 1, wherein the plastic layer comprises polyethylene, polyethylene copolymers, polyamides, EVOH copolymers, EVA copolymers, polypropylene, HDPE, LDPE, LLDPE or the mixture of the aforesaid copolymers.

3. A thermal management multi-layer film/sheet according to claim 1, wherein at least one metal layer can be optionally laminated into either side of the said plastic layer and form a laminate multi-layer film/sheet structure.

4. A thermal management multi-layer film/sheet according to claim 3, wherein the said metal layer comprises nickel, copper, tungsten, molybdenum, aluminum, steel, silver, gold or the alloy of the aforesaid metals.

5. A thermal management multi-layer film/sheet according to claim 2, wherein at least one adhesive layer can be optionally laminated into either side of the said plastic layer and form a laminate multi-layer film/sheet structure, and the said heat conductive particles and microencapsulated-phase-change-material particles can be dispersed uniformly within the said adhesive layer.

6. A thermal management multi-layer film/sheet according to claim 4, wherein at least one adhesive layer can be optionally laminated into either side of the said plastic or metal layer and form a laminate multi-layer film/sheet structure, and the said heat conductive particles and microencapsulated-phase-change-material particles can be dispersed uniformly within the said adhesive layer.

7. A thermal management multi-layer film/sheet according to claim 5 or 6, wherein the said adhesive layer comprises alkyl ester copolymer, alkyl ester or olefins.

8. A thermal management multi-layer film/sheet according to claim 6, wherein the said heat conductive particles comprise silver coated copper powders, silver, nickel, aluminum, copper, tin powders, alloy metal powders, hydride-dehydrogenated titanium powders, stainless powders, graphite powders carbon black powders, nano-metal powders, spherical alumina powders, aluminum nitride powders, hexagonal boron nitride powders, super fine spherical aluminum powders or the sintering body of aforementioned mixer.

9. A thermal management multi-layer film/sheet according to claim 8, wherein the said phase change material is hydrated salt, paraffin or olefin.

10. A thermal management multi-layer film/sheet according to claim 9, wherein the diameter of the said heat conductive particles and microencapsulated-phase-change-material particles is between about 500 microns to 1 micron.

11. A thermal management multi-layer film/sheet according to claim 5 or 6, wherein the thickness of each layers is between about 0.05 microns and 250 microns.

12. A thermal management multi-layer film/sheet according to claim 1, wherein the multi-layer film/sheet structure is produced by the method of co-extrusion, or cast co-extrusion.

13. A thermal management multi-layer film/sheet according to claim 5 or 6, wherein the surface of the said laminate multi-layer film/sheet structure can further include plural extending fins which are composed of the same material as the outer surface plastic layer.

14. A thermal management multi-layer hollow article for the use with the secondary battery and supercapacitor, comprising:
a plurality of the heat conductive particles;
a plurality of the microencapsulated-phase-change-material particles; and
at least one plastic layer including the said heat conductive particles and microencapsulated-phase-change-material particles dispersed uniformly within the said plastic layer;
wherein the said at least one plastic layer take shape in a cylinder, rectangular or other stereo structure with at least one bore goes through the both ends of the center part, and the main body of the cylinder , rectangular or other stereo structure is composed of at least one said multi-layer plastic layer.

15. A thermal management multi-layer hollow article according to claim 14 wherein at least one metal layer can be optionally laminated into either side of the said plastic layer and form a laminate multi-layer hollow article.

16. A thermal management multi-layer hollow article according to claim 14, wherein at least one adhesive layer can be optionally laminated into either side of the said plastic layer and form a laminate multi-layer hollow article, and the said heat conductive particles and microencapsulated-phase-change-material particles can be dispersed uniformly within the said adhesive layer.

17. A thermal management multi-layer hollow article according to claim 15, wherein at least one adhesive layer can be optionally laminated into either side of the said plastic or metal layer and form a laminate multi-layer hollow article, and the said heat conductive particles and microencapsulated-phase-change-material particles can be dispersed uniformly within the said adhesive layer.

18. A thermal management multi-layer hollow article according to claim 17, wherein the each layer of the said laminated multi-layer article can either include plural extending fins or not.

19. A thermal management multi-layer hollow article according to claim 17, wherein the bore is used for inserting prismatic lithium ion battery, cylinder lithium ion battery or supercapacitor.
